(19) United States
(12) Patent Application Publication
(10) Pub. No.: US 2011/0285354 A1
(43) Pub. Date: Nov. 24, 2011

(54) Rechargeable battery controlling circuit, rechargeable battery controlling device, independent power system and battery pack

(76) Inventor: Hiroshi Iwasa, Ise City (JP)

(21) Appl. No.: 13/064,827

(22) Filed: Apr. 20, 2011

(30) Foreign Application Priority Data
May 23, 2010 (JP) 2010-114749
May 23, 2010 (JP) 2010-132,445

(51) Int. Cl. H02J 7/00

(52) U.S. Cl. 320/137

(57) ABSTRACT

This invention offer a rechargeable-battery controlling device and an independent power system that is cheap and low power consumption. First current is created by amplifying and copying current flow through one diode or plural serially connected diodes, and first voltage is created by flowing said first current through resistance load and converting to voltage, and switching element is on-off-controlled by said first voltage, and the switching element works to prevent overcharge and overdischarge. This detects an alteration of voltage and the device protects from overcharge and overdischarge. By this, by small parts, the protection circuit for overcharge and overdischarge can be realized and power consumption can be suppressed.

### CROSS-REFERENCE TO RELATED APPLICATION

The present application claims the benefit application number 2010-132,445, filed in Japan on May 23, 2010, the subject matter of which is hereby incorporated herein by reference.

### STATEMENT REGARDING FEDERALLY SPONSORED RESEARCH OR DEVELOPMENT

The inventor is not sponsored by federal government.

### BACKGROUND OF THE INVENTION

1. Field of invention

The photovoltaic power generation attracts attention in recent years. There are an independent power system and a grid tied system in a photovoltaic system, and in the former it stores electric energy to rechargeable battery from solar panels or solar modules, and when required, the electric energy is used directly or by being converted to AC 100V or 120V etc. depending on country and area. On the other hand, after converting to an alternating current of 100V or 120V etc., if produced electric energy is more than consumed electric energy, the system sell electric energy to electric power company, and if produced electric energy is less than consumed electric energy, the system buy electric energy from electric power company. In this patent, an independent power system includes the system which switches to state so that electric power is supplied by electric power company when the electric power stored in the rechargeable battery decreases.

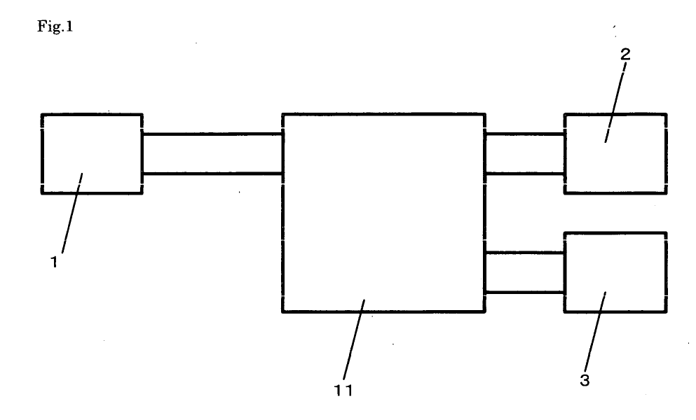

Here, lead storage batterys are used for the rechargeable battery, which are known to have phenomenon called overcharge, which has hazard of explosion and so on, and phenomenon called overdischarge, which cause storable electric charge decrease and may make the battery unusable. Therefore, as shown in FIG. 1, in order to prevent an overcharge and an overdischarge, it is common to use the rechargeable battery controlling device 11 called a charge controller. The rechargeable battery controlling device 11 is connected to the generating device 1, the rechargeable battery 2, and load 3.

In lead storage batteries, the voltage between both electrodes increases against electric charge stored monotonically, and we can predict the quantity of electric charge, i.e., the quantity of a power, by detecting the voltage between both electrodes to some extent.

2. Description of Related Art

In the overcharge preventing circuitry and overdischarge preventing circuitry for preventing the overcharge and overdischarge which conventional rechargeable battery controlling device has, for example, a comparator or comparators compares or compare the voltage obtained by carrying out resistor dividing of the voltage between the both electrode of a rechargeable battery, to a reference voltage or reference voltages, the compared result large or small information is processed by a logic circuit, and turn on and turn off a transistor. as shown in the patent document 1

Patent document 1 U.S. Pat. No. 6,642,694 B2

The charge controller, which is the rechargeable battery controlling device equipped with such a conventional overcharge preventing circuitry and the overdischarge preventing circuitry consumes the electric current of 2 mA for not charging period and 8 mA for charging period even the least power consuming one. Here, when it generates electricity for 8 hours on the one day and assuming the mean electric current at the time of a power was generated is 20 mA, the electric current total amount on one day is calculated to 160 mAh. However, 96 mAh (milliampere hour) of total 160 mA is consumed by the charge controller itself. Thus, in a small-scale independent power system, the electric current consumed by a charge controller is not igonorable. In addition of it, The charge controller, which is the rechargeable battery controlling device equipped with such a conventional overcharge preventing circuitry and the overdischarge preventing circuitry cost a lot because of complexity.

### BRIEF SUMMARY OF INVENTION

An object is to offer a low power consuming and low cost independent-power-systems-oriented rechargeable battery controlling circuit and rechargeable battery controlling device, and an independent power system, using power generating device such as photovoltaic module.

Moreover, if at least one LED is contained in diode or plural serially connected diodes, we can check full charge by radiance of LEDs. By this invention, the protection circuit to an overcharge and an overdischarge is realizable by small parts amount. Moreover, power consumption can be suppressed. Furthermore, We can carry out the visual confirm of the full charge with LEDs. The protection circuit to an overcharge can reduce substantial consumption electric-current by double digit or more. The protection circuit to an overdischarge can reduce substantial consumption electric-current by single or double digit. As a result, We can realize a rechargeable battery controlling device which is cheap and low power consuming, and can realize the small-scale independent power system which is a cheap and low power consuming and can be used without caring about an overcharge and an overdischarge.

FIG. 1 is a schematic diagram of an independent power system.

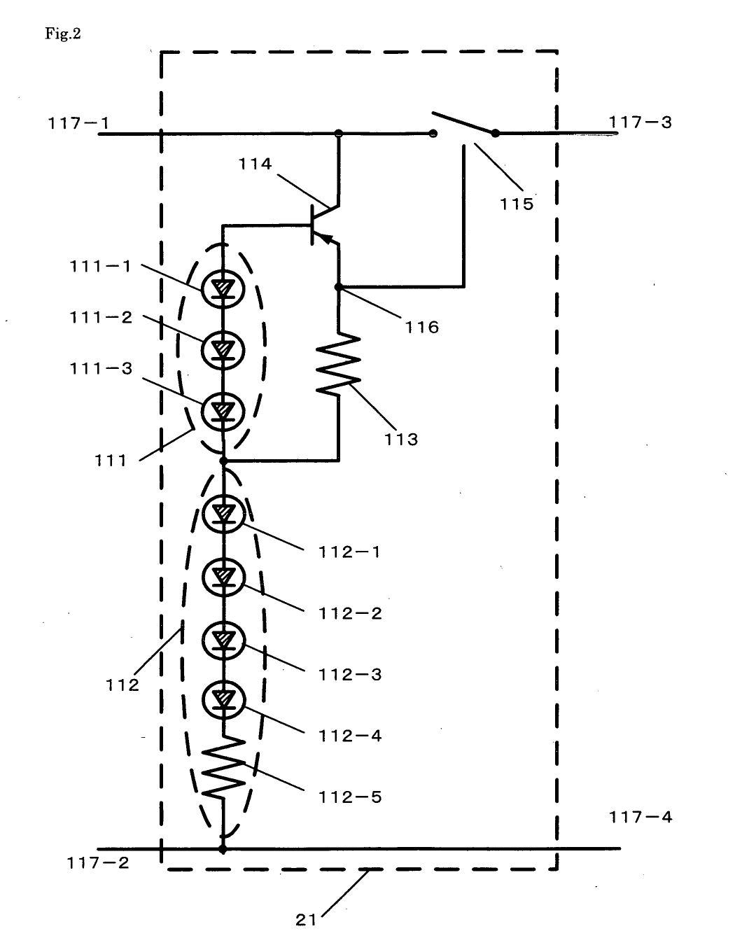

FIG. 2 shows the overcharge preventing circuitry in the mode of the 1st embodiment.

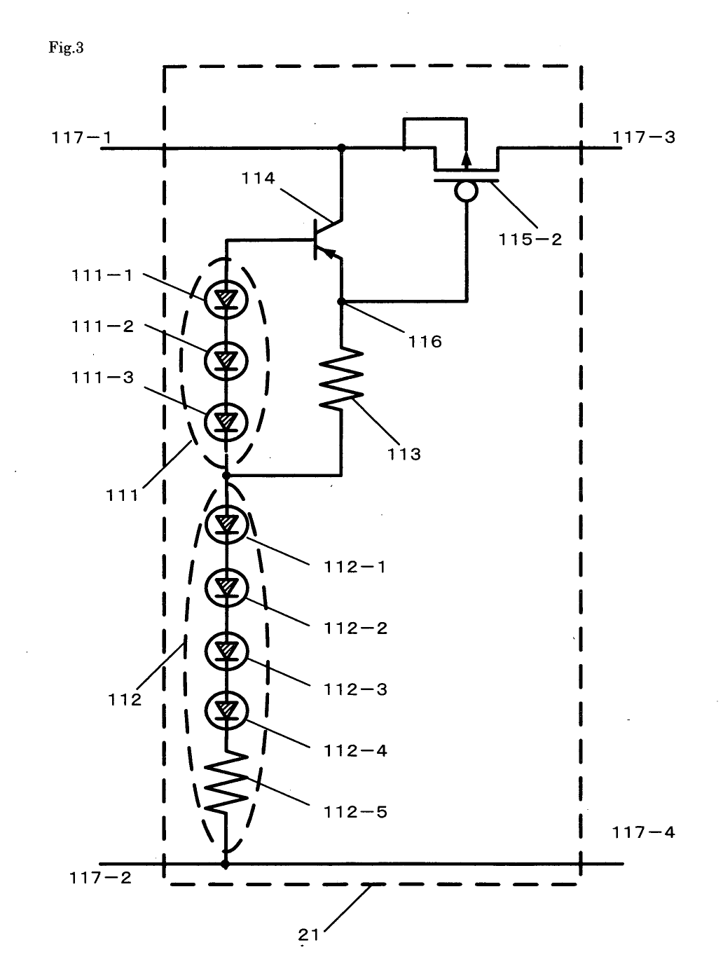

FIG. 3 is a circuit diagram in the case of using PMOS transistor for a switching element in the overcharge preventing circuitry in the mode of the 1st embodiment.

FIG. 4 shows the modification of the overcharge preventing circuitry in the mode of the 1st embodiment.

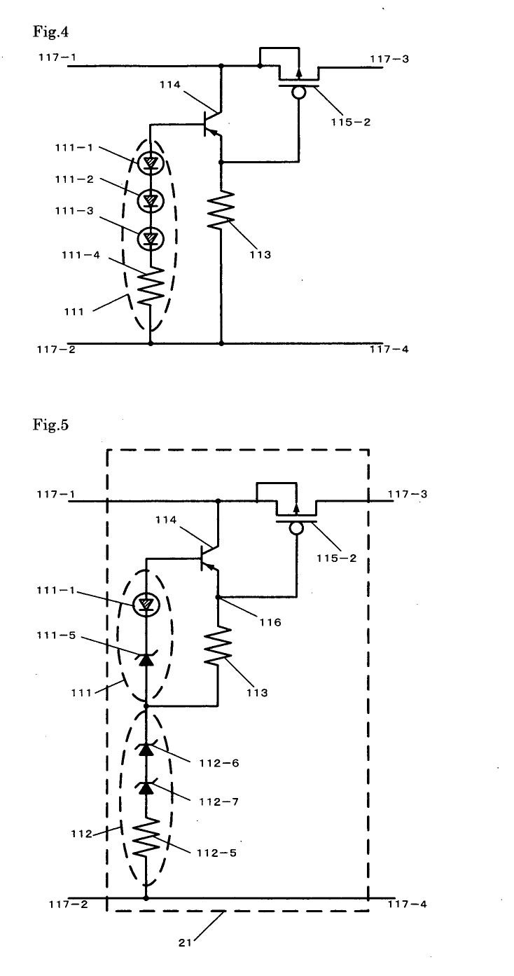

FIG. 5 is a circuit diagram if PMOS transistor is used for a switching element in the overcharge preventing circuitry in the mode of the 2nd embodiment.

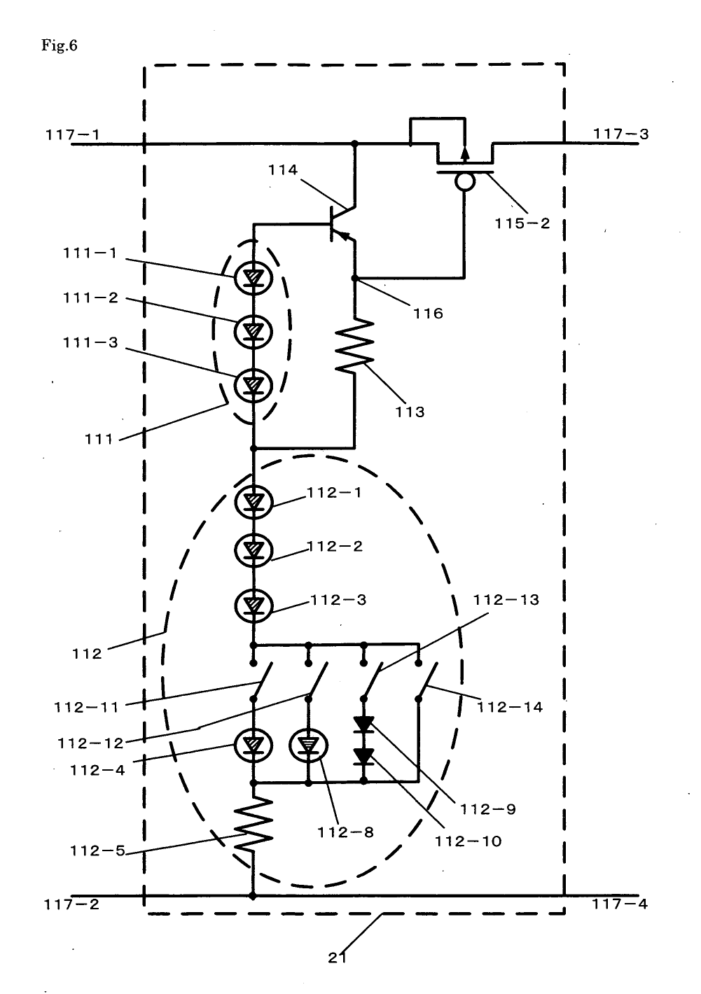

FIG. 6 is a circuit diagram in the case of using PMOS transistor for a switching element in the overdischarge preventing circuitry in the mode of the 3rd embodiment.

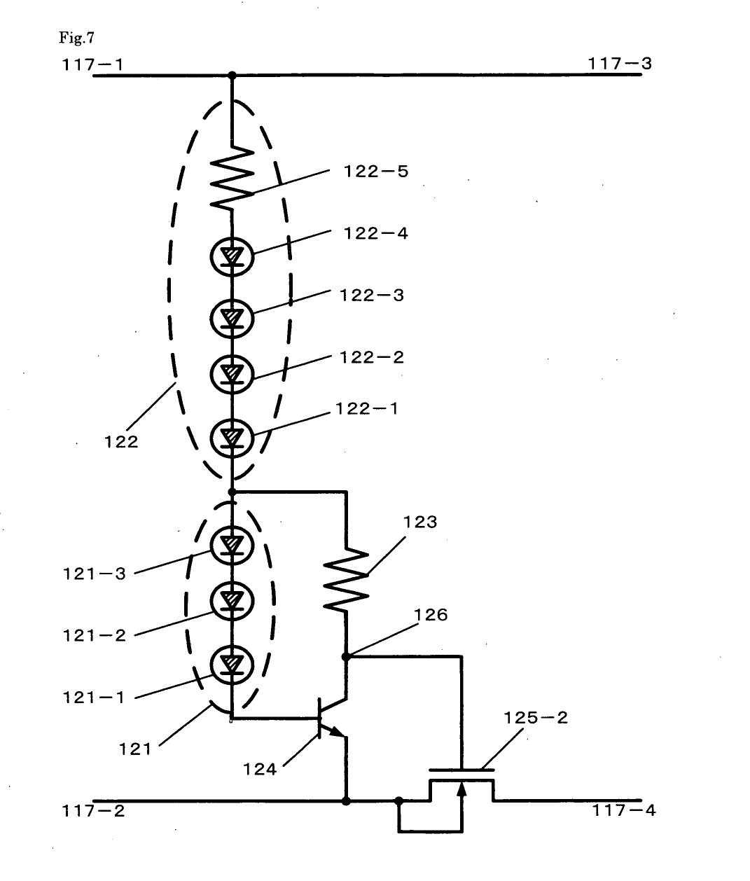

FIG. 7 is a circuit diagram in the case of using n-channel-MOS transistor for a switching element in overcharge preventing circuitry in the mode of the 4th embodiment.

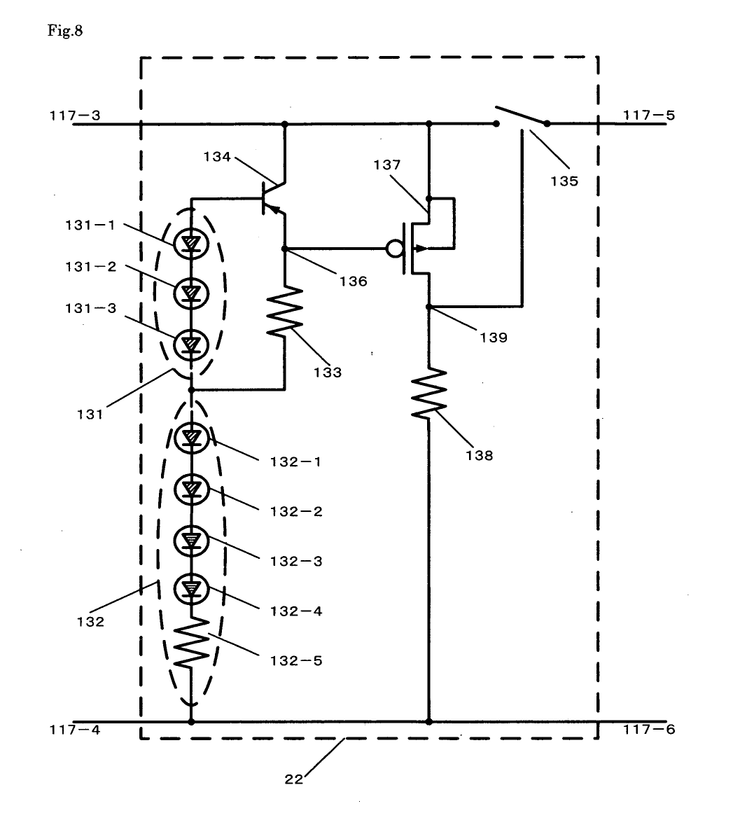

FIG. 8 shows the overdischarge preventing circuitry in the mode of the 5th embodiment.

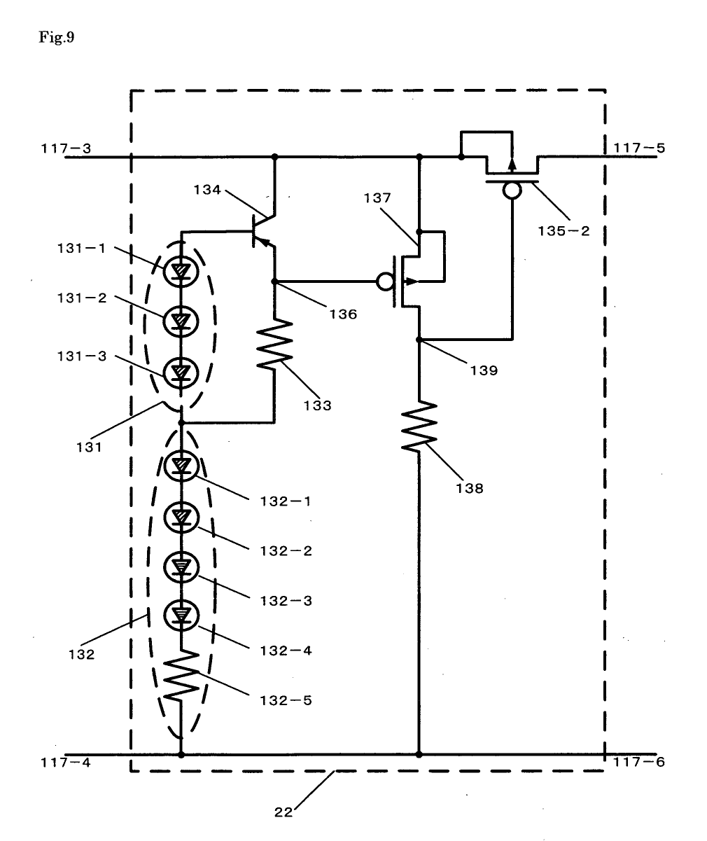

FIG. 9 is a circuit diagram in the case of using PMOS transistor for a switching element in the overdischarge preventing circuitry in the mode of the 5th embodiment.

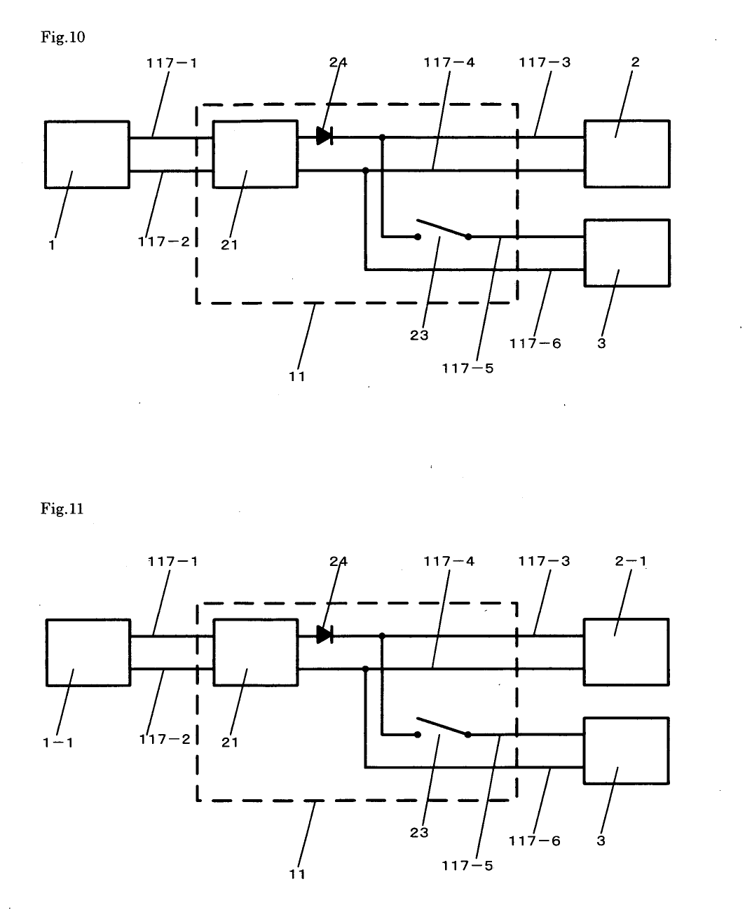

FIG. 10 is a block diagram of the independent power system in the mode of the 6th embodiment.

FIG. 11 is a block diagram in the case of using a lead storage battery for a rechargeable battery, using a photovoltaic as a generating set in the independent power system in the mode of the 6th embodiment.

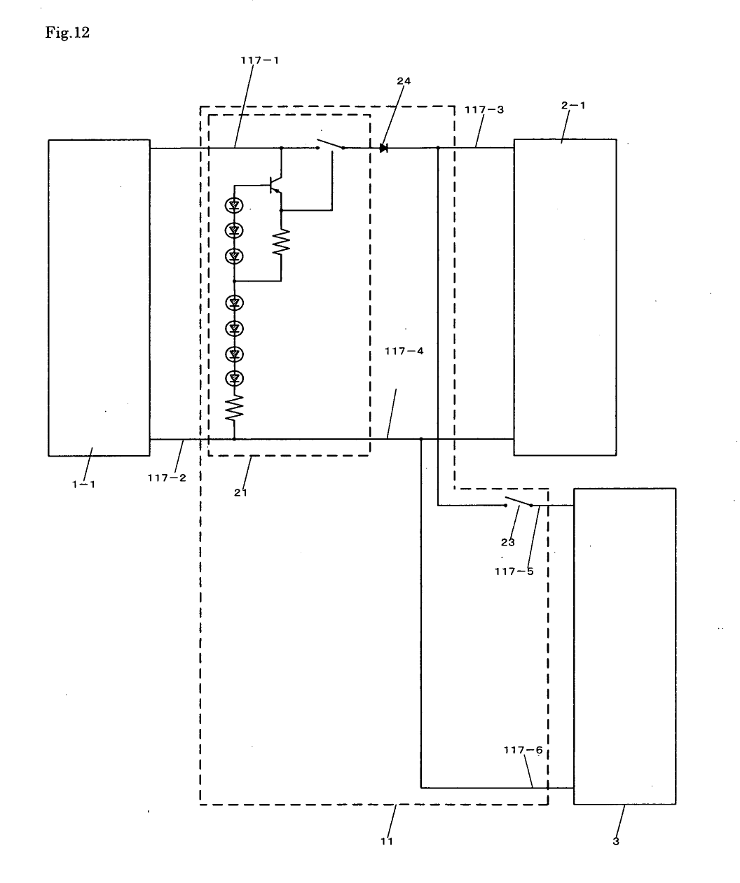

FIG. 12 is a circuit diagram of the independent power system in the mode of the 6th embodiment.

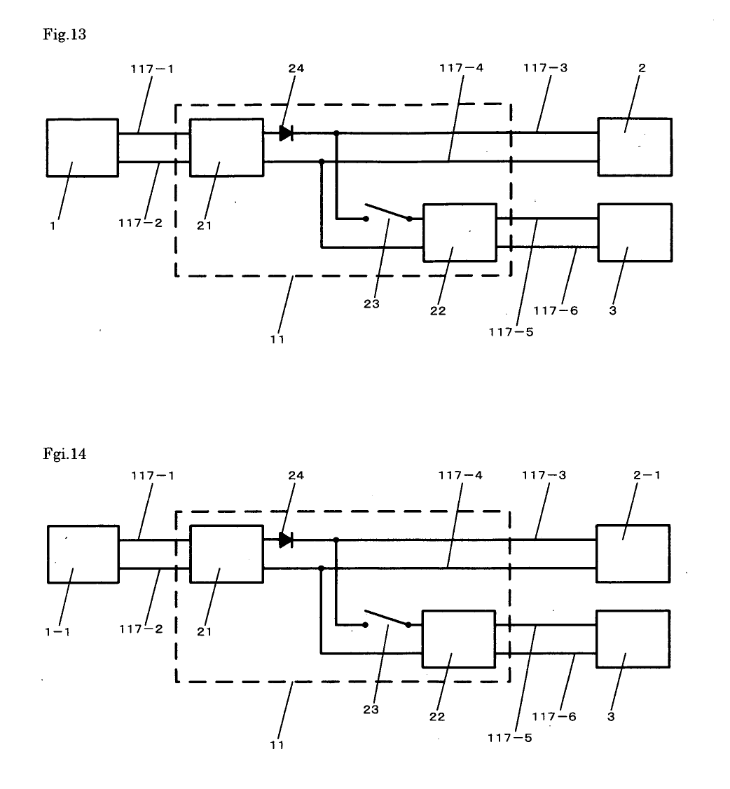

FIG. 13 is a block diagram of the independent power system in the mode of the 7th embodiment.

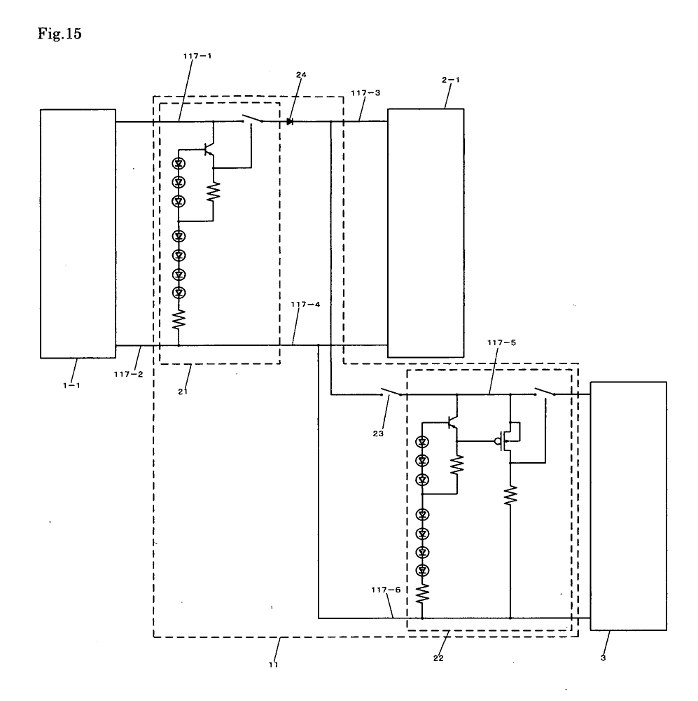

FIG. 14 is a block diagram if a lead storage battery is used for a rechargeable battery, a photovoltaic moidule is used for a power generating device in the independent power system in the 7th embodiment.

FIG. 15 is a circuit diagram of the independent power system in the mode of the 7th embodiment.

### THE 1ST EMBODIMENT

The circuitry of the 1st embodiment is an overcharge preventing circuitry. The circuit diagram of the 1st embodiment is shown in FIG. 2. The circuitry of the 1st embodiment has a PNP type bipolar transistor 114, the first circuitry part 111, the second circuitry part 112, a resistor 113, and a switching element 115. These whole segment is the overcharge preventing circuitry 21. A power-generation-system is defined as the segment, substantially connected to electricity-generating device such as a photovoltaic module, 117-1 and 117-2, and a power-storage-system is defined as the segment substantially connected to a rechargeable battery such as a lead storage battery, 117-3 and 117-4. Although 117-2 and 117-4 are shorted, they are explained as different nodes for illustrative purpose. Being connected substantially means being connected including the case where a fusing, a switch, a resistor, a diode, an ampere meter, etc. are inserted in between.

The collector of the PNP type bipolar transistor 114 is connected with the plus terminal of the power-generation system 117-1, the base is connected to one end of the circuitry part 111, and the emitter is connected to one end of the resistor 113 and the control terminal of the switching element 115. One end of the circuitry part 111 is connected to base of the PNP type bipolar transistor 114, and the other end is connected to the end of the circuitry part 112 and one end of the resistor 113. One end of the circuitry part 112 is connected to one end of the circuitry part 111 and one end of the resistor 113, and the other end is connected to the minus terminal of the power-generation system 117-2 and the minus terminal of power-storage-system 117-4. One end of the resistor 113 is connected to the one end of the circuitry part 111 and one end of the circuitry part 112, and the other end is connected to the emitter of the PNP type bipolar transistor 114 and control terminal of the switching element 115. One end of the switching element 115 is connected to the plus terminal of the power-generation-system 117-1, the control terminal is connected to the emitter of the PNP type bipolar transistor 114 and one end of the resistor 113, and the other end is connected to the plus terminal of the power-storage-system 117-3.

Here, the circuit part 111 and the circuit part 112 contain one diode or plural serially connected diodes respectably. It is also possible to connect parallelly of serially connected diodes, and to connect serially of parallelly connected diodes. Moreover, although the diodes to be used are LEDs in the 1st embodiment, they are not necessarily LEDs. Every kind of LED such as green, red, blue, ultraviolet, and infrared can be used. Moreover, the combination of these diodes may be acceptable and the sum of the voltage drop across the circuit part 111 and the sum of the voltage drop across the circuit part 112 can be adjusted by combinating.

The circuit part 111 and 112 may contain a resistor. This resistor plays the role which restricts the electric current which flows when the voltage between the plus-minus terminals of the power-storage-system becomes high. The 1st embodiment is the examples in the case of that the circuit parts 111 is serially connected green LED 111-1, 111-2, and 111-3, and the circuit part 112 is serially connected green LED 112-1, 112-2, 112-3, 112-4 and resistor 112-5.

A PMOS transistor can be used for the switching element 115. The circuit diagram in the case of using a PMOS transistor for the switching element 115 is shown in FIG. 3. Below, the case where a PMOS transistor is used for the switching element 115 is explained. The collector of the PNP type bipolar transistor 114 is connected to the plus terminal of the power-generation-system 117-1, the base is connected to one end of the circuitry part 111, and the emitter is connected to one end of the resistor 113 and the gate of the PMOS transistor 115-2. One end of the circuitry part 111 is connected to the base of the PNP type bipolar transistor 114, and the other end is connected to one end of the circuitry part 112 and one end of the resistor 113. One end of the circuitry part 112 is connected to one end of the circuitry part 111 and one end of the resistor 113, and the other end is connected to the minus terminal of the power-generation-system 117-2 and the minus terminal of the power-storage-system 117-4. One end of the resistor 113 is connected to one end of the circuitry part 111 and one end of the circuitry part 112, and the other end is connected to the emitter of the PNP type bipolar transistor 114 and the gate of the PMOS transistor 115-2. The source of the PMOS transistor 115-2 is connected to the plus terminal of the power-generation-system 117-1, the gate is connected to the emitter of the PNP type bipolar transistor 114 and the end of the resistor 113, and the drain is connected to the plus terminal of the power-storage-system 117-3.

In this circuitry, the electric current which flows through the circuitry part 111 which contains diodes is determined by the voltage between the plus-minus terminals of the power-generation-system. The electric current which flows through the circuitry part 111 containing diodes increases exponentially to the voltage between both ends around the voltage which the electric current begins to flow through. And the voltage proportional to the electric current which flows through the circuit part 111 containing diodes is created to the both ends of the resistor 113 by amplifying and copying the electric current which flows through the circuit part 111 containing diodes by the PNP type bipolar transistor 114 and flowing through the resistor 113. Since the PMOS transistor 115-2 is controlled by the electric potential of the node 116 determined by this voltage, the PMOS transistor 115-2 raises the resistance between source and drain, as the electric current which flows through the circuitry part 111 containing diodes increases.

If the voltage between the plus-minus terminals of the power-generation-system exceeds a constant voltage value, the electric current which flows through the circuitry part 111 containing diodes exceeds a certain value, the electric potential of the node 116 exceeds a certain value, and the resistance between source and drain of the PMOS transistor 115-2 exceeds a certain value. When a photovoltaic module and so on is connected to the plus-minus terminals of the power-generation-system, at this time, the voltage between the plus-minus terminals of power-generation-system increases more and more, and the resistance between source and drain of. PMOS transistor 115-2 increases more and more by positive feedback. Therefore, the voltage between the plus-minus terminals of the power-generation-system leaps, and the PMOS transistor 115-2 completely turns off.

By becoming like this, the function which does not increase the voltage between the plus-minus terminals of the power-storage-system beyond a constant voltage value is realized by that the PMOS transistor 115-2 turns off and detach the power-generation-system from the power-storage-system if the voltage between the plus-minus terminals of the power-generation-system exceeds the constant voltage value. The electric current consumption of few micro A (microampere) was realized by using three green LEDs for the circuitry part 111, four green LED for the circuitry part 112, a resistor of 300 k ohm for the resistor 113.

The substantial reason for such a thing becomes possible is that complicated amplifier circuit is unnecessary because this circuitry uses the fact that electric currents increases exponentially to the voltage between both terminals around the voltage where electric current begins to flow, and that the electric current which flows through diodes can be adjusted and suppressed by adjusting the number of diodes and the threshold of each diode.

In the case where at least one LED is used for at least one of the circuitry parts 111 and 112, when the power-generation-system and the power-storage-system are detached, it can be checked by visual observation since LEDs emits light by certain amount of brightness. The resistor 112-5 can restrict the electric current which flows at this time. Hundreds of ohm or a few k(kilo) ohm is suitable resistance for the resistor 112-5. By restricting electric current by this resistor 112-5, diodes which have small current capacity can be used, and the size of the circuitry and the device can be suppressed, and the cost can be suppressed.

By the 1st embodiment, a cheap and low power-consumption overcharge preventing circuitry is realized. Furthermore, visual confirm of the full charge can be carried out with LEDs. This circuitry may be in a battery pack.

### MODIFICATION OF THE 1ST EMBODIMENT

The circuit diagram of the modification of the 1st embodiment is shown in the FIG. 4. This circuitry has a PNP type bipolar-transistor 114, a circuitry part 111, a resistor 113, and a PMOS transistor 115-2. These whole segment is equivalent to the overcharge preventing circuitry 21.

The collector of the PNP type bipolar transistor 114 is connected to the plus terminal of the power-generation-system 117-1, the base is connected to one end of the circuitry part 111, and the emitter is connected to one end of the resistor 113 and the gate of the PMOS transistor 115-2. The source of the PMOS transistor 115-2 is connected to the plus terminal of the power-generation-system 117-1, the gate is connected to the emitter of the PNP type bipolar transistor 114 and one end of the resistor 113, and the drain is connected to the plus terminal of the power-storage-system 117-3.

The circuitry part 111 contains one diode or plural serially connected diodes. It is also possible to connect parallelly of serially connected diodes, and to connect serially of parallelly connected diodes. Moreover, the diodes to be used are not necessarily LEDs. Zener diodes may be used. Silicon diodes and Schottky barrier diodes with less voltage drop may be used. Moreover, the combination of these diodes may be acceptable. The circuitry parts 111 and 112 may also contain a resistor. This resistor plays the role which restricts the electric current which flows when the voltage between the plus-minus terminators of the power-storage-system becomes high. Although the operation and principle of the modification of the 1st embodiment are the same as that of the 1st original embodiment, the modification of the 1st embodiment is suitable for the system with low voltage.

### THE 2ND EMBODIMENT

The 2nd embodiment is another mode of the overcharge preventing circuitry. The circuit diagram of the 2nd embodiment is shown in FIG. 5. The switching element is shown as a PMOS transistor 115-2.

Same as the circuitry of the 1st embodiment, the circuitry of 2nd embodiment has a PNP type bipolar transistor 114, the first circuit part 111, the second circuit part 112, and a resistor 113 and a PMOS transistor 115-2. These whole segment is the overcharge preventing circuitry 21.

The circuitry part 111 and the circuitry part 112 contain one diode or plural serially connected diodes. The 2nd embodiment is the example wherein a serial connection of a green LED 111-1 and a Zener diode 111-5 is used for circuit part 111 and a serial connection of the Zener diodes 112-6, 112-7 and a resistor 112-5 is used for circuit part 112.

Thus, Zener diodes may be used. The Zener diodes are available from what have small voltage drop to what have large voltage drop, and sum value of voltage drop can be adjusted with a small element number. By this resistor 112-5, the electric current which flows can be restricted when the voltage between the plus-minus terminals of the power-storage-system becomes high.

The operation and the principle of the 2nd embodiment are same as that of the 1st embodiment. By the 2nd embodiment, an overcharge preventing circuitry which is cheap and low power consumption is realized. Furthermore, the visual confirm of the full charge can be carried out with an LED.

### THE 3RD EMBODIMENT

The 3rd embodiment is another mode of the overcharge preventing circuitry. The circuit diagram of the 3rd embodiment is shown in FIG. 6. The switching element is shown as a PMOS transistor 115-2. Same as the circuitry of the 1st embodiment and 2nd embodiment, the circuitry of 3rd embodiment has a PNP type bipolar transistor 114, the first circuit part 111, the second circuit part 112, and a resistor 113 and a PMOS transistor 115-2. These whole segment is the overcharge preventing circuitry 21.

The circuit part 111 and the circuit part 112 contain one diode or plural serially connected diodes. It is also possible to connect parallelly of serially connected diodes, and to connect serially of parallelly connected diodes. In the 3rd embodiment, in at least one of circuit part 111 or the circuit part 112, number of the diodes or the kind of the diodes or both on the path the electric current flow can be changed by switches. By doing like this, the voltage drop in a correspondent circuit part can be adjusted. Mechanical switches, such as DIP switch, or MOS transistors which are connected to the controlling circuit, and so on may be used for the switches which change the path which electric current flows.

As for the circuit part 111, the example in the case of green LEDs 111-1, 111-2, and 111-3 is shown, same as the 1st embodiment. The circuit part 112 has green LEDs 112-1, 112-2, 112-3, 112-4, a red LED 112-8, silicon diodes 112-9, 112-10, switches 112-11, 112-12, 112-13, and 112-14. The anode of the green LED 112-1 is connected to outside of the circuit part 112, and the cathode is connected to the anode of green LED 112-2. The anode of the green LED 112-2 is connected to the cathode of green LED 112-1, and the cathode is connected to the anode of green LED 112-3. The anode of the green LED 112-3 is connected to the cathode of the green LED 112-2, and the cathode is connected to one end of the switches 112-11, 112-12, 112-13, and 112-14.

One end of the switch 112-11 is connected to cathode of the green LED 112-3, one end of the switches 112-12, 112-13, and 112-14, and the other end is connected to the anode of the green LED 112-4. One end of the switch 112-12 is connected to the cathode of the green LED 112-3, the switches 112-11, 112-13, and 112-14, and the other end is connected to the anode of the red LED 112-8. One end of the switch 112-13 is connected to the cathode of the green LED 112-3, the switches 112-11, 112-12, and 112-14, and the other end is connected to the cathode of the silicon diode 112-9. One end of the switch 112-14 is connected to the cathode of the green LED 112-3, one end of the switches 112-11, 112-12, and 112-13, and the other end is connected to the cathode of the green LED 112-4, the cathode of the red LED 112-8, the cathode of the silicon diode 112-10, one end of the resistor 112-5.

The anode of the green LED 112-4 is connected to one end of the switch 112-11, and the cathode is connected to the cathode of the red LED 112-8, the cathode of the silicon diode 112-10, one end of the switch 112-14, and one end of the resistor 112-5. The anode of the red LED 112-8 is connected to one end of the switch 112-12, and the cathode is connected to the cathode of the green LED 112-4, the cathode of the silicon diode 112-10, one end of the switch 112-14, and one end of the resistor 112-5. The anode of the silicon diode 112-9 is connected to the switch 112-13, and the cathode is connected to the anode of the silicon diode 112-10. The anode of 112-10 is connected to the cathode of the silicon diode 112-9, and the cathode is connected to the cathode of the green LED 112-4, the cathode of the red LED 112-8, one end of the switch 112-14, and one end of the resistor 112-5.

One end of the resistor 112-5 is connected to the cathode of the green LED 112-4, the cathode of the red LED 112-8, the cathode of the silicon diode 112-10, and one end of the switch 112-14, and the other end is connected to outside of the circuit part 112. The voltage drop across circuit part 112 decreases in the order of 112-11, 112-12, 112-13, 112-14 for the switch to be on. Although the 3rd embodiment is an example which adjusts the amount of voltage drop across the circuit part 112, the amount of voltage drop across the circuit part 111 may be adjusted, and amount of voltage drops of both circuit part 111 and circuit part 112 may be adjusted.

The operation and the principle of the 3rd embodiment are the same as that of the 1st embodiment. By the 3rd embodiment, an overcharge preventing circuitry which is cheap and low power consumption is realized. Furthermore, the visual confirm of the full charge can be carried out with a light emitting diode.

### THE 4TH EMBODIMENT

The circuit of the 4th embodiment is an implementation mode of another overcharge preventing circuit. The circuit diagram of the 4th embodiment is shown in FIG. 7. The switching element is shown as a NMOS transistor 115-2. The circuit of the 4th embodiment has the NPN type bipolar transistor 124, the circuit part 121, the circuit part 122, the resistor 123, and the n-channel-MOS transistor 125-2. These whole segment is the overcharge preventing circuit 21.

The power-generation-system is defined as the segment, substantially connected to electricity-generating device such as a photovoltaic module, 117-1 and 117-2, and the power-storage-system is defined as the segment substantially connected to a rechargeable battery such as a lead storage battery, 117-3 and 117-4. Although 117-1 and 117-3 are shorted, they are explained as different nodes for illustrative purpose. Being connected substantially means being connected including the case where a fusing, a switch, a resistor, a diode, an ampere meter, etc. are inserted in between.

The emitter of the NPN type bipolar transistor 124 is connected to the minus terminal of the power-generation-system 117-2, the base is connected to one end of circuit part 121, and the collector is connected to one end of the resistor 123 and the gate of n-channel-MOS transistor 125. One end of the circuit part 121 is connected to the base of the NPN type bipolar transistor 124, and the other end is connected to one end of the circuit part 122 and one end of the resistor 123. And one end of the circuit part 122 is connected to one end of the circuit part 121 and one end of resistor 123, and the other end is connected to the plus terminal of the power-generation-system 117-1 and the plus terminal of the power-storage-system 117-3. One end of the resistor 123 is connected to one end of the circuit part 121 and one end of the circuit part 122, and the other end is connected to the collector of the NPN type bipolar transistor 124 and the gate of the n-channel-MOS transistor 125-2. The source of the n-channel-MOS transistor 125 is connected to the minus terminal of the power-generation-system 117-3, the gate is connected to the collector of the NPN type bipolar transistor 124 and one end of the resistor 123, and the drain is connected to the minus terminal of the power-storage-system 117-4.

If the voltage between the plus-minus terminals of the power-generation-system exceeds a constant voltage value, the electric current which flows through the circuit part 121 containing diodes will exceed a certain value, the electric potential of the node 126 decreases below a certain value, the resistance between source and drain of the n-channel-MOS transistor 125-2 exceeds a certain value. When a photovoltaic module and so on is connected to the plus-minus terminals of the power-generation-system, at this time, the voltage between the plus-minus terminals of power-generation-system increases more and more, and the resistance between source and drain of PMOS transistor 125-2 increases more and more by positive feedback. Therefore, the voltage between the plus-minus terminals of the power-generation-system leaps, and the PMOS transistor 125-2 completely turns off. By becoming like this, the function which does not increase the voltage between the plus-minus terminators of the power-storage-system beyond a constant voltage value is realized by that the PMOS transistor 125-2 turns off and detach the power-generation-system from the power-storage-system if, the voltage between the plus-minus terminals of the power-generation-system exceeds the constant voltage value.

By the 4th embodiment, a cheap and low power-consumption overcharge preventing circuitry is realized. Furthermore, the visual confirm of the full charge can be carried out with LEDs.

### THE 5TH EMBODIMENT

The circuitry of the 5th embodiment is an overdischarge preventing circuitry. The circuit diagram of the 5th embodiment is shown in FIG. 8. The circuit of the 5th embodiment has a PNP type bipolar transistor 134, the first circuit part 131, the second circuit part 132, a resistor 133, a resistor 138, a PMOS transistor 137, and a switching element 135. These whole segment is the overdischarge preventing circuitry 22.

Power-storage-system is defined as the segment substantially connected to rechargeable batteries such as a lead storage battery, 117-3 and 117-4, and output system is defined as the segment substantially connected to loads such as lamps, 117-5, 117-6. Although 117-4 and 117-6 are shorted, they are explained as different nodes for illustrative purpose. Being connected substantially means being connected including the case where a fusing, a switch, a resistor, a diode, an ampere meter, etc. are inserted in between.

The collector of the PNP type bipolar transistor 134 is connected to the plus terminal of the power-storage-system 117-3, the base is connected to the anode of the circuit part 131, and the emitter is connected to one end of the resistor 133 and the gate of PMOS transistor 137. One end of the circuit part 131 is connected to the base of the PNP type bipolar transistor 134, and the other end is connected to one end of circuit part 132 and one end of the resistor 133. One end of the circuit part 132 is connected to one end of the circuit part 131 and one end of the resistor 133, and the other end is connected to the minus terminal of the power-storage-system 117-4 and the minus terminal of the output-system 117-6. One end of the resistor 133 is connected to one end of the circuit part 131 and one end of the circuit part 132, and the other end is connected to the emitter of the PNP type bipolar transistor 134 and the gate of the PMOS transistor 137.

The source of the PMOS transistor 137 is connected to the plus terminal of the power-storage-system 117-3, the gate is connected to the emitter of the PNP type bipolar transistor 134 and one end of the resistor 133, and the drain is connected to one end of the resistor 138 and the control terminal of the switching element 135. One end of the resistor 138 is connected to the drain of the PMOS transistor 137 and the control terminal of the switching element 135, and the other end is connected to the minus terminal of the power-storage-system 117-4 and the minus terminal of an output-system 117-6. One end of the switching element 135 is connected to the plus terminal of the power-storage-system 117-3, the control terminal is connected to the drain of the PMOS transistor 137 and one end of the resistor 138, and one end is connected to the plus terminal of the output-system 117-5.

Here, the circuit part 111 and the circuitry part 112 contain one diode or plural serially connected diodes. It is also possible to connect parallelly of serially connected diodes, and to connect serially of parallelly connected diodes. Moreover, although the diodes to be used are LEDs in the 5th embodiment, they are not necessarily LEDs. Every kind of LED such as green, red, blue, ultraviolet, and infrared can be used. Furthermore, Zener diodes may be used and silicon diodes or a Schottky barrier diodes, which have less voltage drop, may be used. Moreover, the combination of these diodes may be acceptable and the sum of the voltage drop across the circuit part 131 and the sum of the voltage drop across the circuit part 132 can be adjusted by combinating.

The circuit part 131 and 132 may contain a resistor. This resistor plays the role which restricts the electric current which flows when the voltage between the plus-minus terminals of the power-storage-system becomes high. The 5th embodiment is the examples in the case of that the circuit parts 131 is serially connected green LEDs 131-1, 131-2, and 131-3, and the circuit part 132 is a serially connection of green LEDs 132-1, 132-2, red LEDs 132-3, 132-4 and resistor 132-5.

A PMOS transistor can be used for the switching element 135. The circuit diagram in the case of using a PMOS transistor for the switching element 135 is shown in FIG. 9. Below, the case where a PMOS transistor is used for the switching element 135 is explained.

The collector of the PNP type bipolar transistor 134 is connected to the plus terminal of the power-storage-system 117-3, the base is connected to one end of the circuit part 131, and the emitter is connected to one end of the resistor 133 and the gate of the PMOS transistor 137. One end of the circuit part 131 is connected to the base of the PNP type bipolar transistor 134, and the other end is connected to one end of the circuit part 132 and one end of the resistor 133. One end of the circuit part 132 is connected to one end of the circuit part 131 and one end of the resistor 133, and the other end is connected to the minus terminal of the power-storage-system 117-4 and the minus terminal of the output-system 117-6.

One end of the resistor 133 is connected to one end of the circuit part 131 and one end of the circuit part 132, and the other end is connected to the emitter of the PNP type bipolar transistor 134 and the gate of the PMOS transistor 137. The source of the PMOS transistor 137 is connected to the plus terminal of the power-storage-system 117-3, the gate is connected to the emitter of the PNP type bipolar transistor 134 and one end of the resistor 133, and the drain is connected to the resistor 138 and the gate of the PMOS transistor 135-2. One end of the resistor 138 is connected to the drain of the PMOS transistor 137 and the gate of the PMOS transistor 135-2, and the other end is connected to the minus terminal of the power-storage-system 117-4 and the minus terminal of the output-system 117-6. The source of the PMOS transistor 135-2 is connected to the plus terminal of the power-storage-system 117-3, the gate is connected to the drain of the PMOS transistor 137 and one end of the resistor 138, and the drain is connected to the plus terminal of the output-system 117-5. The source of the PMOS transistor 135-2 is connected to the plus terminal of the power-storage-system 117-3, the gate is connected to the drain of the PMOS transistor 137 and one end of the resistor 138, and the drain is connected to the plus terminal of the output-system 117-5.

In this circuitry, the electric current which flows through the circuit part 131 which contains diodes is determined by the voltage between the plus-minus terminals of the power-generation-system. The electric current which flows through the circuit part 131 containing diodes increases exponentially to the voltage between both ends around the voltage which the electric current begins to flow through. And the voltage proportional to the electric current which flows through the circuit part 131 containing diodes is created to the both ends of the resistor 133 by amplifying and copying the electric current which flows through the circuitry part 131 containing diodes by the PNP type bipolar transistor 134 and flowing through the resistor 133. The PMOS transistor 137 is driven by the electric potential of the node 136 which is determined by this voltage, and the electric potential of the node 136 is inverted and copied to the electric potential of node 139 by the electric current PMOS transistor 136 flows and resistor 138. Since the PMOS transistor 135-2 is controlled by the electric potential of the node 139, the PMOS transistor 135-2 raises the resistance between source and drain, as the electric current which flows through the circuitry part 131 containing diodes decreases.

If the voltage between the plus-minus terminals of the power-generation-system decreases below a constant voltage value, the electric current which flows through the circuitry part 131 containing diodes decreases below a certain value, the electric potential of the node 136 decreases below a certain value, the electric potential of the node 139 exceeds a certain value, and the resistance between source and drain of the PMOS transistor 135-2 exceeds a certain value. By the amplification stage by the PMOS transistor 137 and the resistor 138, the resistance between the source and drain of the PMOS transistor 135-2 can be increased sharply by slight decrement of the voltage between the plus-minus terminals of the power-storage-system. By becoming like this, the function which does not decrease the voltage between the plus-minus terminals of the power-storage-system below the constant voltage value is realized by that the output-system and the power-storage-system are detached if the voltage between the plus-minus terminals of the power-generation-system decreases below the constant voltage value. Since positive feedback does not arise unlike the 1st embodiment, in order to raise sharply the resistance between the source and drain of the PMOS transistor 135 by slight decrement of the voltage between the plus-minus terminals of the power-storage-system, the amplification stage by the PMOS transistor 137 and the resistor 138 is required.

Power consumption of this overdischarge preventing circuitry could be suppressed to tens of micro A (micro-ampere). The substantial reason for such a thing becomes possible is that complicated aplifier circuit is unnecessary because this circuitry uses the fact that electric current increases exponentially to the voltage between both terminals around the voltage where electric current begins to flow, and that the electric current which flows through diodes can be adjusted and suppressed by adjusting the number of diodes and the threshold of each diode. The constant voltage value which determines whether to detach the power generation-system and the power-storage-system can be adjusted by the number or threshold of serially connected diodes, or resistance of resistor 138.

By the 5th embodiment, a cheap and low power-consumption overdischarge preventing circuitry is realized. Furthermore, the visual confirm of the full charge can be carried out with LEDs. Like the relation between 4th embodiment and 1st embodiment, the overdischarge preventing circuitry of 5th embodiment can be realized by using NMOS transistors.

[The 6th embodiment]

The 6th embodiment is a rechargeable battery controlling device and independent power system which uses the overcharge preventing circuitry. The independent power system of the 6th embodiment is shown in FIG. 10.

In the independent power system of the 6th embodiment, a generating set 1 is connected to a rechargeable battery 2 through a reverse-current preventing diode 24 and an overcharge preventing circuitry 21, and load 3 is connected to the rechargeable battery 2 through a mechanical switch 23.

The overcharge preventing circuitry 21, the reverse-current preventing diode 24, and the mechanical switch 23 constitute the rechargeable battery controlling device 11. Thus, the generating set 1, the rechargeable battery 2, and the load 3 are connected to the rechargeable battery controlling device 11. The reverse-current preventing diode 24 may be between the rechargeable battery 2 and the overcharge preventing circuitry 21 or may be between the generating set 1 and the overcharge preventing circuitry 21. The reverse-current preventing diode 24 may be in the inside of the rechargeable battery controlling device 11, or may be in the outside. The reverse-current preventing diode 24 may be united with the generating set 1.

Power-generation-system is defined as the segment, substantially connected to electricity-generating device such as a photovoltaic module, 117-1 and 117-2, and power-storage-system is defined as the segment substantially connected to rechargeable batteries such as a lead storage battery, 117-3 and 117-4, and output system is defined as the segment substantially connected to load such as lamps, 117-5, 117-6. Although 117-2, 117-4 and 117-6 are shorted, they are explained as different nodes for illustrative purpose. Being connected substantially means being connected including the case where a fusing, a switch, a resistor, a diode, an ampere meter, etc. are inserted in between.

Power generating device which use natural energy is suitable for power generating device 1. Especially a photovoltaic module is suitable. A lead storage battery can be used for the rechargeable battery 2. The example in the case of using a photovoltaic module for the generating set 1, and using a lead storage battery for the rechargeable battery 2 is shown in FIG. 11. Below, the case where a photovoltaic module is used for the generating set 1, and a lead storage battery is used for the rechargeable battery 2 is explained.

In the independent power system of the 6th embodiment, a photovoltaic module 1-1 is connected to a lead storage battery 2-1 through a reverse-current preventing diode 24 and an overcharge preventing circuitry 21, and load 3 is connected to the lead storage battery 2-1 through a mechanical switch 23. The overcharge preventing circuitry 21, the reverse-current preventing diode 24, and the mechanical switch 23 constitute the rechargeable battery controlling device 11. Thus, the photovoltaic module 1-1, the lead storage battery 2-1, and the load 3 are connected to the rechargeable battery controlling device 11. The reverse-current preventing diode 24 may be between the lead storage battery 2-1 and the overcharge preventing circuitry 21 or may be between the photovoltaic module 1-1 and the overcharge preventing circuitry 21. The reverse-current preventing diode 24 may be in the inside of the rechargeable battery controlling device 11, or may be in the outside. The reverse-current preventing diode 24 may be united with the photovoltaic module 1-1.

The circuit diagram which indicated the inside of the overcharge preventing circuitry 21 is shown in FIG. 12. The inside of the overcharge preventing circuitry 21 is explained in the 1st embodiment, FIG. 2, and FIG. 3. A PMOS transistor can be used for the switching element 115 in FIG. 2. The inside of the overcharge preventing circuitry 21 when a PMOS transistor is used for the switching element 115 is shown in FIG. 3. The circuitry part 111 in FIG. 3 contains at least one LED or one Zener diode. Since the inside of the overcharge preventing circuitry 21 is explained in the 1st embodiment, FIG. 2, and FIG. 3, a detailed explanation is omitted.

The voltage between the plus-minus terminals of the photovoltaic module 1-1 maintains a status a little higher than the voltage between a plus-minus of the lead storage battery 2-1 at the time of power generation. If the voltage between the plus-minus terminals of the power-generation-system exceeds a first constant voltage value, the electric current which flows through the circuitry part 111 containing diodes will exceed a certain value, the electric potential of the node 116 exceeds a certain value, and the resistance between source and drain of the PMOS transistor 115-2 exceeds a certain value. As a result, the voltage between the plus-minus terminals of photovoltaic module 1-1 increases more and more, and the resistance between source and drain of PMOS transistor 115-2 increases more and more by positive feedback. Therefore, the voltage between the plus-minus terminals of the photovoltaic module 1-1 leaps, and the PMOS transistor 115-2 completely turns off. By becoming like this, the function which does not increase the voltage between the plus-minus terminals of the lead storage battery beyond a constant voltage value is realized by that the PMOS transistor 115-2 turns off and detach the photovoltaic module from the lead storage battery if the voltage between the plus-minus terminals of the photovoltaic module exceeds the constant voltage value. Like this, overcharge preventing function is realized.

When the power-generation-system and the power-storage-system are detached, the voltage between the plus-minus terminals of the photovoltaic module 1-1 turns into a high voltage in the range below the open-circuit voltage of the photovoltaic module. In the case where at least one LED is used for at least one of the circuitry parts 111 and 112, when the power-generation-system and the power-storage-system are detached, it can be checked by visual observation since LEDs emit light by a certain amount of brightness. The resistor 112-5 can restrict the electric current which flows at this time. Hundreds of ohm or a few k(kilo) ohm is suitable resistance for the resistor 112-5. By restricting electric current by this resistor 112-5, diodes which have small current capacity can be used, and the size of the circuitry and the device can be suppressed, and the cost can be suppressed.

The constant voltage value of the standard which detaches the power-generation-system and the power-storage-system, i.e., the photovoltaic module 1-1 and the lead storage battery 2-1, is 13.2V, for example.

The mechanical switch 23 is a switch which decides whether to supply an electric current to the load, and may not exist. A load is a lighting etc., for example. When night comes, sunlight will stop shining upon the photovoltaic module 1-1, and the voltage between the plus-minus terminals of the photovoltaic module 1-1 will turn into a voltage sufficiently smaller than the voltage of the criterion of an overcharge. Therefore, if the voltage between the plus-minus terminals of the lead storage battery 2-1 has fallen because of the electric current consumed by the load 3, a charging will be started to the lead storage battery 2-1 at the same time the sun rises on the next day. A by-pass switch between the plus terminal 117-1 of the photovoltaic 11, and the plus terminal 117-3 of the lead storage battery 2-1 may be adopted. A charging starts when this by-pass switch turns on temporarily, if the voltage between the plus-minus terminals of the lead storage battery 2-1 is below the criterion voltage of an overcharge preventing circuitry.

By the function of the reverse-current preventing diode 24, the power currently stored in the lead storage battery 2-1 does not flow into backward direction through the inside of the photovoltaic module 1-1 at night. If the configuration is such that the reverse-current preventing diode 24 is between the lead storage battery 2-1 and the overcharge preventing circuitry 21, the electric current consumption of the overcharge preventing circuitry 21 at night, when power generation and charging don't ocuur, can be suppressed still smaller.

By the 6th embodiment, a cheap and low power-consumption independent power system which doesn't need care about overcharge is realized. Furthermore, the visual confirm of the full charge can be carried out with LEDs.

### MODIFICATION OF THE 6TH EMBODIMENT

Modification of the 6th embodiment is different in that, it uses Zener diodes for the circuit parts 111 and 112.

The inside of the overcharge preventing circuitry 21 is explained in the 2nd embodiment and FIG. 5. FIG. 5 is a figure in the case of using a PMOS transistor 115-2 as a switching element. The circuitry part 111 in FIG. 5 contains at least one LED or one Zener diode. FIG. 5 is an example in case the circuitry part 111 is a serial connection of the green LED 111-1 and the Zener diode 111-5.

An operation and principle of the modification of the 6th embodiment are the same as that of the 6th original embodiment.

### THE 7TH EMBODIMENT

The 7th embodiment is a rechargeable battery controlling device and independent power system which uses the overcharge preventing circuitry and the overdischarge preventing circuitry.

The independent power system of the 7th embodiment is shown in FIG. 13. In the independent power system of the 7th embodiment, a generating set 1 is connected to a rechargeable battery 2 through a reverse-current preventing diode 24 and an overcharge preventing circuitry 21, and load 3 is connected to the rechargeable battery 2 through a mechanical switch 23 and an overdischarge preventing circuitry 22.

The overcharge preventing circuitry 21, overdischarge preventing circuitry 22, the reverse-current preventing diode 24, and the mechanical switch 23 constitute the rechargeable battery controlling device 11. Thus, the generating set 1, the rechargeable battery 2, and the load 3 are connected to the rechargeable battery controlling device 11.

The reverse-current preventing diode 24 may be between the rechargeable battery 2 and the overcharge preventing circuitry 21 or may be between the generating set 1 and the overcharge preventing circuitry 21. The reverse-current preventing diode 24 may be in the inside of the rechargeable battery controlling device 11, or may be in the outside. The reverse-current preventing diode 24 may be united with the generating set 1.

Power-generation-system is defined as the segment, substantially connected to electricity-generating device such as a photovoltaic module, 117-1 and 117-2, and power-storage-system is defined as the segment substantially connected to rechargeable batteries such as a lead storage battery, 117-3 and 117-4, and output system is defined as the segment substantially connected to load such as lamps, 117-5, 117-6. Although 117-2, 117-4 and 117-6 are shorted, they are explained as different nodes for illustrative purpose. Being connected substantially means being connected including the case where a fusing, a switch, a resistor, a diode, an ampere meter, etc. are inserted in between.

Power generating device which use natural energy is suitable for power generating device 1. Especially a photovoltaic module is suitable. A lead storage battery can be used for the rechargeable battery 2. The example in the case of using a photovoltaic module for the generating set 1, and using a lead storage battery for the rechargeable battery 2 is shown in FIG. 14. Below, the case where a photovoltaic module is used for the generating set 1, and a lead storage battery is used for the rechargeable battery 2 is explained.

In the independent power system of the 7th embodiment, a photovoltaic module 1-1 is connected to a lead storage battery 2-1 through a reverse-current preventing diode 24 and an overcharge preventing circuitry 21, and load 3 is connected to the lead storage battery 2-1 through a mechanical switch 23 and overdischarge preventing circuitry 22.

The overcharge preventing circuitry 21, the overdischarge preventing circuitry 22, the reverse-current preventing diode 24, and the mechanical switch 23 constitute the rechargeable battery controlling device 11. Thus, the photovoltaic module 1-1, the lead storage battery 2-1, and the load 3 are connected to the rechargeable battery controlling device 11.

The circuit diagram which indicates the inside of the overcharge preventing circuitry 21 and the overdischarge preventing circuitry 22 is shown in FIG. 15. Since the inside of the overcharge preventing circuitry 21 is explained in the 1st embodiment, FIG. 2, and FIG. 3, a detailed explanation is omitted. Since the inside of the overdischarge preventing circuitry 22 is explained in the 5th embodiment, FIG. 8, a detailed explanation is omitted.

The voltage between the plus-minus terminals of the photovoltaic module 1-1 maintains a status a little higher than the voltage between a plus-minus of the lead storage battery 2-1 at the time of a power generation. If the voltage between the plus-minus terminals of the power-generation-system exceeds a first constant voltage value, the electric current which flows through the circuitry part 111 containing diodes will exceed a certain value, the electric potential of the node 116 exceeds a certain value, and the resistance between source and drain of the PMOS transistor 115-2 exceeds a certain value. As a result, the voltage between the plus-minus terminals of photovoltaic module 1-1 increases more and more, and the resistance between source and drain of PMOS transistor 115-2 increases more and more by positive feedback. Therefore, the voltage between the plus-minus terminals of the photovoltaic module 1-1 leaps, and the PMOS transistor 115-2 completely turns off. By becoming like this, the function which does not increase the voltage between the plus-minus terminals of the lead storage battery beyond the first constant voltage value is realized by that the PMOS transistor 115-2 turns off and detach the photovoltaic module from the lead storage battery if the voltage between the plus-minus terminals of the photovoltaic module exceeds the first constant voltage value. Like this, overcharge preventing function is realized.

When the power-generation-system and the power-storage-system are detached, the voltage between the plus-minus terminals of the photovoltaic module 1-1 turns into a high voltage in the range below the open-circuit voltage of a photovoltaic module. In the case where at least one LED is used for at least one of the circuitry parts 111 and 112, when the power-generation-system and the power-storage-system are detached, it can be checked by visual observation since LEDs emit light by a certain amount of brightness. The resistor 112-5 can restrict the electric current which flows at this time. Hundreds of ohm or a few k(kilo) ohm is suitable resistance for the resistor 112-5. By restricting an electric current by this resistor 112-5, diodes which have small current capacity can be used, and the size of the circuitry and the device can be suppressed, and the cost can be suppressed.

The first constant voltage value of the standard which detaches the power-generation-system and the power storage-system, i.e., the photovoltaic module 1-1 and the lead storage battery 2-1, is 13.2V, for example.

The mechanical switch 23 is a switch which determines whether to supply an electric current to the load, and may not exist. A load is a lighting etc., for example. If the voltage between the plus-minus terminals of the lead storage battery 2-1 decreases below a second constant voltage value, the electric current which flows through the circuitry part 131 containing diodes decreases below a certain value, the electric potential of the node 136 decreases below a certain value, the electric potential of the node 139 exceeds a certain value, and the resistance between source and drain of the PMOS transistor 135-2 exceeds a certain value. By the amplification stage by the PMOS transistor 137 and the resistor 138, the resistance between the source and drain of the PMOS transistor 135-2 can be increased sharply by slight decrement of the voltage between the plus-minus terminals of the power-storage-system. By becoming like this, the function which does not decrease the voltage between the both terminals of the photovoltaic module 1-1 below the second constant voltage value is realized by that the load 3 and the lead storage battery 2-1 are detached if the voltage between the plus-minus terminals of the power-generation-system decrease below the second constant voltage value. Like this, overdischarge preventing function is realized.

The second constant voltage value of the standard which detaches the power-storage-system and the output-system, i.e., the lead storage battery 2-1 and load 3, is 11.2V, for example. The first constant voltage value is designed certainly more highly than the second constant voltage value. In order to make the first constant voltage value different from the second constant voltage value, there is a method of changing the amount of voltage drops of the circuit part 111 and the circuit part 131, or changing the amount of voltage drops of the circuit part 112 and the circuit part 132. For example, there can be a methodology such that while a serial connection of four green LEDs is used in the circuit part 112, a serial connection of two green LEDs and two red LEDs is used in the circuit part 132. It is possible that when the output-system and the power-storage-system are detached by the overdischarge preventing function, power is supplied from an electric power company.

When night comes, sunlight will stop shining upon the photovoltaic module 1-1, and the voltage between the plus-minus terminals of the photovoltaic module 1-1 will turn into a voltage sufficiently smaller than the voltage of the criterion of overcharge. Therefore, if the voltage between the plus-minus terminals of the lead storage battery 2-1 has fallen because of the electric current consumed by the load 3, a charging will be started to the lead storage battery 2-1 at the same time the sun rises on the next day.

A by-pass switch between the plus terminal 117-1 of the photovoltaic 1-1 and the plus terminal 117-3 of the lead storage battery 2-1 may be adopted. A charging starts when this by-pass switch turns on temporarily, if the voltage between the plus-minus terminals of the lead storage battery 2-1 is below the criterion voltage of an overcharge preventing circuitry. On the other hand, as soon as the voltage between the plus-minus terminals of the lead storage battery 2-1 returns, the connection between the lead storage battery 2-1 and the load 3 is resumed.

By the function of the reverse-current preventing diode 24, the power currently stored in the lead storage battery 2-1 does not flow into a backward direction through the inside of the photovoltaic module 1-1 at night. If the configuration is such that the reverse-current preventing diode 24 is between the lead storage battery 2-1 and the overcharge preventing circuitry 21, the electric current consumption of the overcharge preventing circuitry 21 at night, when power generation and charging don't ocuur, can be suppressed still smaller. By the 7th embodiment, a cheap and low power-consumption independent power system which doesn't need care about overcharge and overdischarge is realized. Furthermore, the visual confirm of the full charge can be carried out with LEDs.

### INDUSTRIAL AVAILABILITY

This invention can be used for the electric power system for the traffic signs, directional arrows, and signboards which is turned on in the night in mountain area where power-transmission cost is large, for example. A photovoltaic module and overcharge preventing circuitry can be used for the product for keeping a battery from going up, when not riding in an automobile for a long period of time.

What is claimed is:

1. Rechargeable battery controlling circuit,
wherein first current is created by amplifying and copying current flow through one diode or plural serially connected diodes,
wherein first voltage is created by flowing said first current through resistance load and converting to voltage,
wherein switching element is on-off-controlled by said first voltage.

2. Rechargeable battery controlling circuit as claimed in claim 1,
wherein said switching element is at least one MOS transistor.

3. Rechargeable battery controlling circuit as claimed in claim 1,
wherein said one diode or plural serially connected diodes contains or contain at least one LED.

4. Rechargeable battery controlling circuit as claimed in claim 1,
wherein said one diode or plural serially connected diodes contains or contain at least one Zener diode.

5. Rechargeable battery controlling circuit as claimed in claim 1,
wherein amount of diode or kind of diode or both on the channel that current flows through said one diode or plural serially connected diodes is changeable by switch.

6. Rechargeable battery controlling device,
wherein first current is created by amplifying and copying current flow through one diode or plural serially connected diodes,
wherein first voltage is created by flowing said first current through resistance load and converting to voltage,
wherein first switching element is on-off-controlled by said first voltage,
wherein when power generating device voltage increases over a first constant voltage, current flow through said one diode or plural serially connected diodes increases and by switching off said first switching element, power generating device and rechargeable battery are detached.

7. Rechargeable battery controlling device as claimed in claim 6,
wherein said first switching element is at least one MOS transistor.

8. Rechargeable battery controlling device as claimed in claim 6,
wherein said one diode or plural serially connected diodes contains or contain at least one LED.

9. Rechargeable battery controlling device as claimed in claim 6,
wherein second current is created by amplifying and copying current flow through second one diode or plural serially connected diodes,
wherein second voltage is created by flowing said second current through resistance load and converting to voltage,
wherein third voltage is created by amplifying said second voltage,
wherein second switching element is on-off-controlled by said third voltage,
wherein when power generating device voltage decreases below second constant voltage, current flow through said one diode or plural serially connected diodes decrease and by switching off said second switching element, power generating device and rechargeable battery are detached,
wherein said first constant voltage is higher than said second constant voltage.

10. Rechargeable battery controlling device as claimed in claim 9,
wherein said first switching element and said second switching element is at least one MOS transistor.

11. Rechargeable battery controlling device as claimed in claim 9,
wherein said first one diode or plural serially connected diodes contains or contain at least one LED.

12. Independent power system comprising a power generating device and a rechargeable battery,
wherein first current is created by amplifying and copying current flow through one diode or plural serially connected diodes,
wherein first voltage is created by flowing said first current through resistance load and converting to voltage,
wherein first switching element is on-off-controlled by said first voltage,
wherein when power generating device voltage increases over first constant voltage, current flow through said one diode or plural serially connected diodes increases and by switching off said first switching element, said power generating device and said rechargeable battery are detached.

13. Independent power system as claimed in claim 12,
wherein said switching element is at least one MOS transistor.

14. Independent power system as claimed in claim 12,
wherein second current is created by amplifying and copying current flow through second one diode or plural serially connected diodes,
wherein second voltage is created by flowing said second current through resistance load and converting to voltage,
wherein third voltage is created by amplifying said second voltage,
wherein second switching element is on-off-controlled by said third voltage,
wherein when power generating device voltage decreases below second constant voltage, current flow through said one diode or plural serially connected diodes decrease and by switching off said second switching element, output-system and said rechargeable battery are detached,
wherein said first constant voltage is higher than said second constant voltage.

15. Independent power system as claimed in claim 14,
wherein said switching element is at least one MOS transistor.

16. Independent power system as claimed in claim 12,
wherein said power generating device uses natural energy.

17. Independent power system as claimed in claim 12,
wherein said power generating device is a photovoltaic module or a photovoltaic panel or a photovoltaic array.

18. Independent power system as claimed in claim 17,
wherein said rechargeable battery is a lead-acid battery.

19. Independent power system as claimed in claim 18,
wherein said one diode or plural serially connected diodes contains or contain at least one LED.

20. Battery pack,
which has rechargeable battery controlling circuit as claimed in claim 1.
